(19) United States
(12) Patent Application Publication
(10) Pub. No.: US 2015/0042010 A1
(43) Pub. Date: Feb. 12, 2015

(54) PRODUCTION METHOD FOR BASEBALL AND SOFTBALL COVER

(71) Applicant: SHYI-MING Chen, Kaohsiung (TW)

(72) Inventor: SHYI-MING Chen, Kaohsiung (TW)

(21) Appl. No.: 14/071,071

(22) Filed: Nov. 4, 2013

(30) Foreign Application Priority Data
Aug. 8, 2013 (TW) 102128422

(51) Int. Cl. A63B 45/00; B29C 70/68; B29C 70/84; B29C 65/70

(52) U.S. Cl. CPC A63B 45/00; B29C 65/70; B29C 70/682; B29C 70/84; B29L 2009/00
USPC 264/257

(57) ABSTRACT

A production method for forming a baseball and softball cover whereby a ball core is one of any exiting baseball and softball cores built independently. An even layer of fibrous material in an elected thickness is affixed onto the ball core and liquid Polyurethane is applied to fully impregnate the fibrous material layer. The soaked ball core is then placed into a soft or flexible figure-8 ball cover shaping mold before it is locked in a metal mold holder. Heating and curing occur and the molds are removed to reveal a finished ball, of which the Polyurethane ball cover embedded with fibrous material becomes an integral part, while it simultaneously bonds itself firmly with the ball core in the molding process. The finished ball consequently acquires a molded one-piece ball cover with an even thickness throughout for added durability and integrity for performance.

### BACKGROUND OF THE INVENTION

1. Field of the invention

This invention relates to a production method for forming a baseball or softball cover, in particular, a ball cover which is molded by Polyurethane with fibrous material embedded and the production method thereof.

2. Description of Related Art

Currently the regulation baseballs and softballs are constructed with an elastic spherical core and a leather ball cover. The ball cover, commonly made of cowhide leather, PU-coated split leather, synthetic leather and so on, involves two figure-8 shaped panels stitched together to enclose the elastic spherical core and thereby form the complete ball. Where the two figure-8 shaped panels are sewn together to form the cover of the baseball and softball, stitched seams are created on the ball cover. The two figure-8 shaped panels are usually hand-stitched, thereby requiring a high degree of skill from the worker and costs for employing these highly skilled workers are continuously on the rise; in addition, the sources for leather used for the ball cover are limited and the price of genuine leather is ever increasing. As a result, the costs of producing baseballs and softballs are continuing to increase. These two figure-8 shaped panels, which are sewn together, are also subject to external forces, for example, if the ball is used in wet or damp conditions, water or moisture can enter the core of the ball through the two adjoining figure-8 shaped panels at the seams, resulting in the ball gaining extra weight. Part of the ball cover becomes swollen and loosened, and the ball starts to change shape and lose integrity. These changes affect the hardness and performance of the ball, and therefore the original physical characteristics of the ball are compromised and the lifespan of the ball is greatly reduced.

As a result, Polyurethane material has been developed for ball covers. Current production methods of Polyurethane ball cover for baseball and softball use a ball core which is independently built, and which is then placed in either a mold cavity of two attaching hemispherical mold pieces, or a mold cavity of two corresponding figure-8 ball cover shaping mold pieces (the latter of which the inventor of this present application had previously applied for, and was granted, U.S. Pat. No. 8,342,832 B2 and U.S. Pat. No. 8,535,470 B2). Both types of the molds utilize protruding pins, which are fixed on the interior of the molds to support the ball core in place, thereby creating a small surrounding gap in between the ball core and the interior wall of the molds. This surrounding gap determines and makes for the intended thickness of the finished ball cover. An injection inlet is set on the exterior of the molds extending into the interior cavity thereof. Liquid Polyurethane material is then injected into this surrounding gap and encases the ball core after cured. Lastly the molds are removed to reveal the ball.

However, the ball produced this way still has several defects: When the two hemispherical mold pieces are separated, the mold parting line resulting from where the two molds join is pronounced across the middle of the finished ball. Also, noticeable marks and attendant hardened lumps left respectively of the injection inlet and the overflow outlet will reside on the ball cover. Most importantly, because the ball cores are not all the same exact size, when the ball core rests on the protruding pins which are fixed on the interior of the mold, the surrounding gap will consequently vary, going eccentric in relation to the ball core, within the interior of the mold, thereby resulting in an uneven or inconsistent thickness of the ball cover when Polyurethane is injected into the mold. On the other hand, when a figure-8 ball cover shaping mold is used, even though the mold parting line, the injection inlet and the overflow outlet are all designed to coincide with or at the center line of the simulated stitched seams of the finished ball cover, so as to spare the aforementioned residual marks and attendant lumps left on the finished ball cover, but as with the two hemispherical molds, the defect of inconsistent thickness of the finished ball cover continues to exist as long as the protruding pins fixed inside the mold remain in practice to support ball core of varied size. Therefore, using these two different types of molds, of either the hemispherical or the figure-8 ball cover shaping pattern, to form Polyurethane ball cover is not ideal given the inconsistent thickness and consequently the insufficient durability strength of the ball cover. When the ball is used for a period of time, the ball cover tends to get loosened, deformed, worn or split, thereby impairing the integrity and decreasing the lifespan of the ball.

As can be seen from the above, the conventional methods of producing ball cover have disadvantages, are not well designed and in need of improvement.

### SUMMARY OF THE INVENTION

The main purpose of this present invention is to provide a production method for forming a ball cover for a baseball or softball as an alternate option for the currently used cowhide or synthetic leather ball covers, and to solve the issues of the molded ball covers with the inconsistent thickness and consequently the insufficient durability strength prevalent in the prior art.

The methods to achieve the above goals are:

A production method for forming a baseball or softball cover, which includes the following steps:

1) An independent ball core is first built;

2) A layer of fibrous material serving as a base in an elected and consistent thickness is fixed over this ball core, and a liquid Polyurethane material is infused into and fully impregnates the fibrous layer;

3) This soaked ball core is then placed inside a soft or flexible ball cover shaping mold and then again in a metal mold holder;

4) Heat is applied and curing occurs at approximately 70° C. for 2 hours;

5) The mold pieces are removed to reveal a finished ball with a molded ball cover.

The ball core in step 1 above is one of any existing softball or baseball cores, which is made of Polyurethane, rubber, cork, composite, or wool wound in multiple layers; which can also be made in a combination of any of the aforementioned materials.

The fibrous material layer in step 2 above serving as a foundation material is made of pile, felt, natural or synthetic fibers, natural or synthetic yarns, natural non-woven cloth, synthetic non-woven cloth, natural woven cloth, synthetic woven cloth, or a combination, either wound or laminated, of two or more of the aforementioned materials.

The ball cover mold equipment in step 3 above involves two corresponding figure-8 ball cover shaping ball cover mold pieces and a metal mold holder. In order to ease separation and removal of the two figure-8 ball cover shaping mold pieces from each other, the two figure-8 ball cover shaping mold pieces are made of soft or flexible plastic material and in the shape of a clamshell. The two corresponding figure-8 ball cover shaping mold pieces join together to form the ball cover appearance and the ball body. These two figure-8 ball cover shaping mold pieces are then locked into the metal mold holder, allowing them to stay tightly engaged when the heating and curing process is occurring in the above step 4.

When the layer of fibrous material serving as a base and fully impregnated with liquid Polyurethane is wrapped over the independent ball core, this fiber-embedded Polyurethane overlay, which simultaneously bonds itself firmly with the surface of the ball core, is molded into a ball cover integral to the ball body after it is heated and cured in the mold. This finished ball cover gets to acquire comparable durability strength to genuine leather ball cover.

In order for the Examiner to more clearly understand the purpose, shape, structure and method of this invention, below are detailed figures showing the embodiment, and a detailed description of the invention.

### BRIEF DESCRIPTION OF THE DRAWINGS

FIG. 1 shows a sectional view of the ball of the present invention.

FIG. 2 is a schematic diagram showing a first embodiment of the ball cover mold of the present invention.

FIG. 3 is a schematic diagram showing a second embodiment of the ball cover mold of the present invention.

FIG. 4 is a top view schematic diagram showing an embodiment of the ball cover mold of the present invention.

FIG. 5 is a sectional view schematic diagram showing an embodiment of the ball cover mold of the present invention.

FIG. 6 is a block diagram of the production process of the present invention.

### DETAILED DESCRIPTION OF THE INVENTION

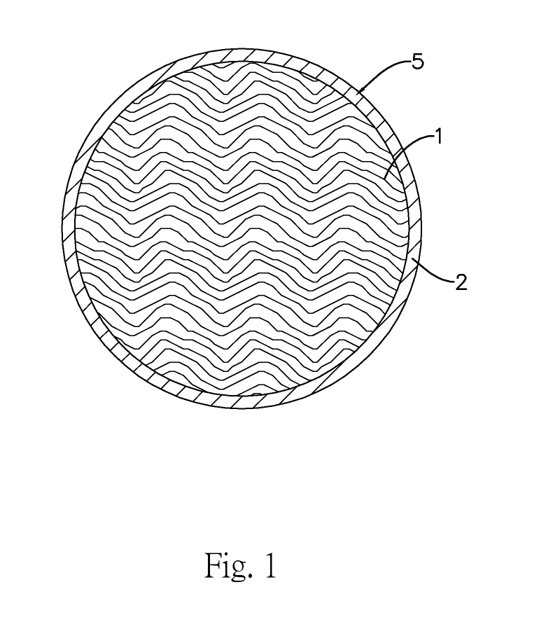

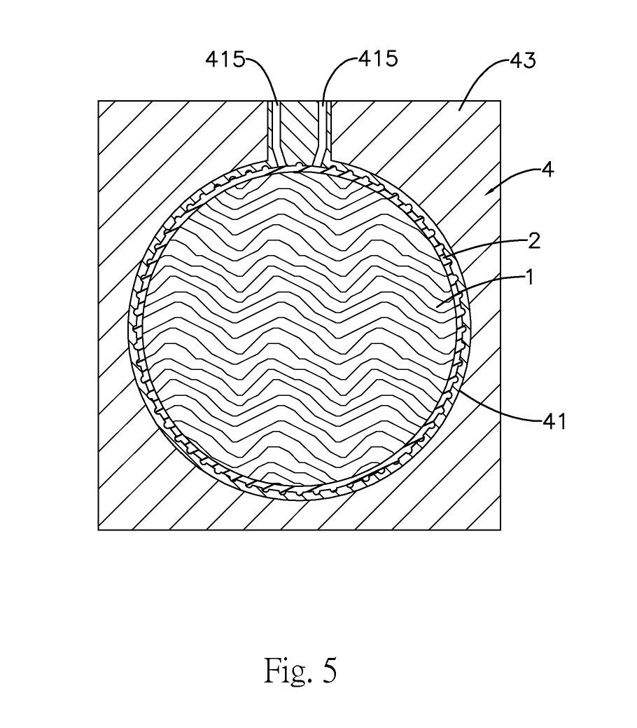

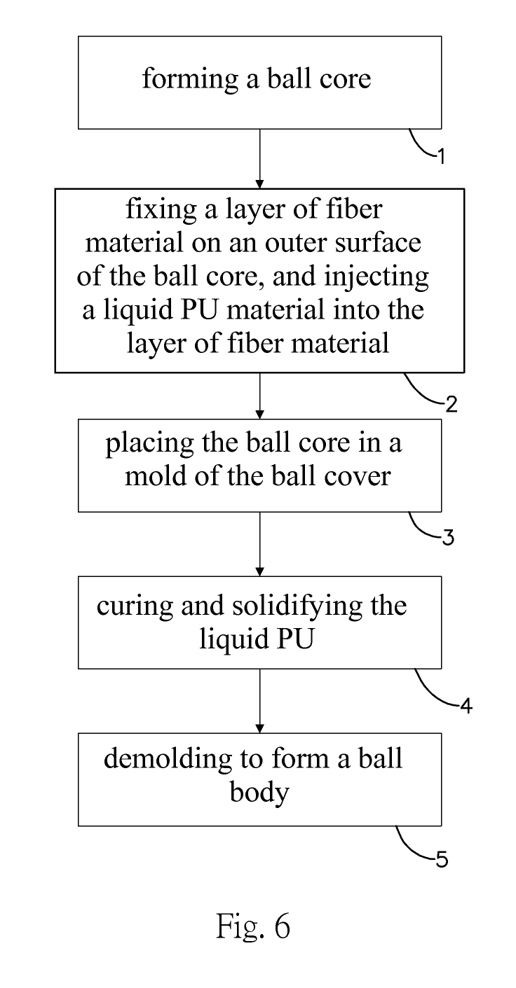

Please refer to FIGS. 1 to 6, which show the production method of forming a baseball or softball cover in the present invention. The main steps are:

(1) First, a ball core 1 as shown in FIG. 1 is built independently;

(2) A fibrous layer 2 serving as a foundation material is structured of a consistent thickness and is fixed over the outer surface of this ball core; and a Polyurethane material is then applied to thoroughly soak into this fibrous layer 2;

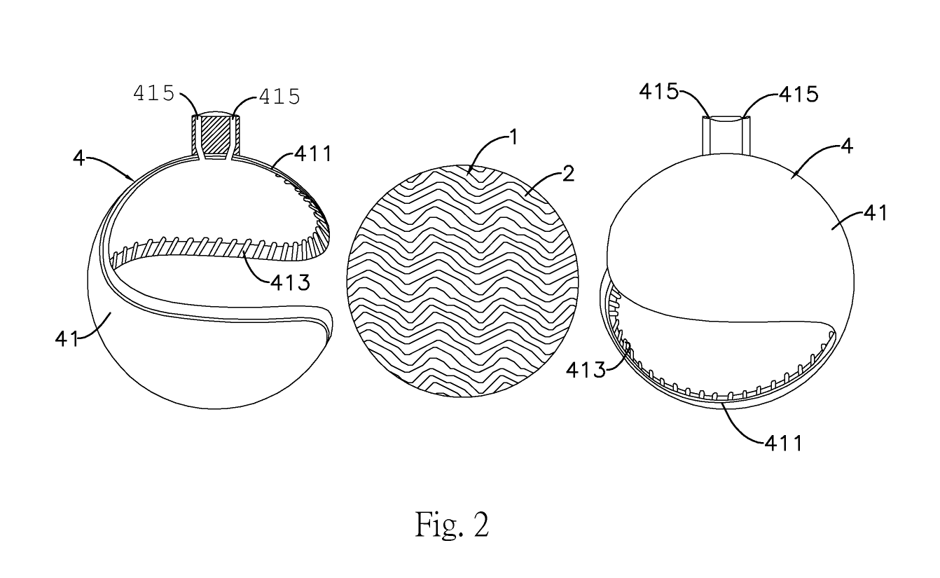

(3) Please refer to FIGS. 2, 3 and 4, which show the placement of the soaked ball core 1 inside a ball cover shaping mold 4;

(4) Heat is applied and curing occurs at approximately 70° C. for 2 hours;

(5) The mold pieces are removed to reveal a finished ball with a molded ball cover embedded with fibrous material.

FIG. 1 shows the independently built ball core 1, which is one of the existing ball cores commonly used in regulation baseballs and softballs; which is made of Polyurethane, rubber, cork, composite, or wool yarns wound in multiple layers; and which can also be made in a combination of any of the aforementioned materials, such as Polyurethane and cork mixed core, or cork and rubber mixed core.

FIG. 1 shows the fibrous layer 2, which serves as a foundation material; which is made of pile, felt, natural or synthetic fibers, natural or synthetic yarns, natural non-woven cloth, synthetic non-woven cloth, natural woven cloth, synthetic woven cloth, or a combination, either wound or laminated, of two or more of the aforementioned materials.

The fibrous layer 2 in itself is porous or is full of voids, in case that the fibrous layer is yarn-wound, so as to quickly absorb and get fully impregnated with the liquid Polyurethane. In this invention, the fibrous layer 2 is constructed to be of a consistent thickness regardless of it being a single piece, padded, laminated, or wound structure. This fibrous layer, by utilizing its even thickness as a base to wrap over the ball core, is thereby capable of

a) determining and making for the thickness of the finished ball cover;

b) centering the ball core inside the mold cavity and achieving an identical thickness throughout the finished ball cover;

after it is cured and removed from the mold. In other words, this even fibrous layer 2 plays the same role of centering the ball core inside the figure-8 ball cover shaping mold, as do the protruding pins fixed in the cavity of those molds used in the prior art.

It follows hence that, by electing a consistent thickness of fibrous layer 2 to serve as a base material, an identical thickness of the finished ball cover 5 can consequently be achieved. For practical purposes, the fibrous layer is elected to comprise a thickness of between approximately 1.2 mm to 1.4 mm, preferably at 1.3 mm, as commonly requested for regulation baseball; or a thickness of between approximately from 1.4 mm to 1.6 mm, preferably at 1.5 mm for regulation softball, while this present invention can run, but is not limited to, a wider range of the finished cover thickness from approximately 0.5 mm to 2.5 mm. Within that wider range, any specific thickness intended for the finished ball cover can thereby be implemented by constructing the corresponding thickness of fibrous layer.

On the other hand, in the case of each individual ball core varying slightly in size in production, the Polyurethane-infused fibrous layer can actually respond to accommodate it within the confines of the cavity of the mated mold, and continues to achieve a consistent thickness throughout the finished ball cover 5, thanks to the porous characteristic of the fibrous layer 2 which yields to compensate for the sizing difference. The liquid Polyurethane can be injected, sprayed or brushed into the fibrous layer.

The liquid Polyurethane can be pigmented in white, optic yellow, or any color, as meets the mandatory cover color for regulation baseballs or softballs as shown in FIG. 1.;

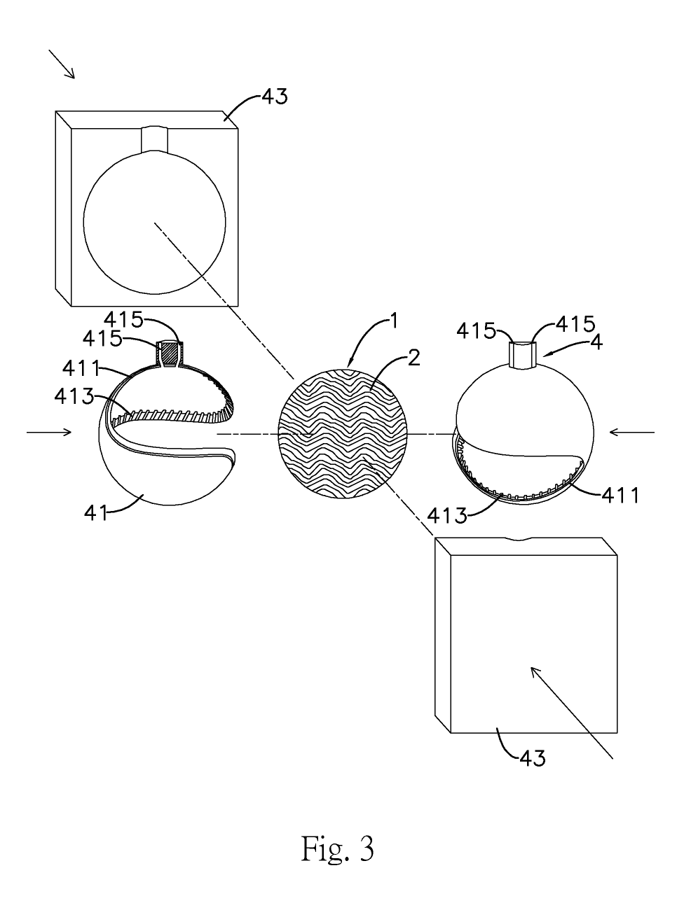

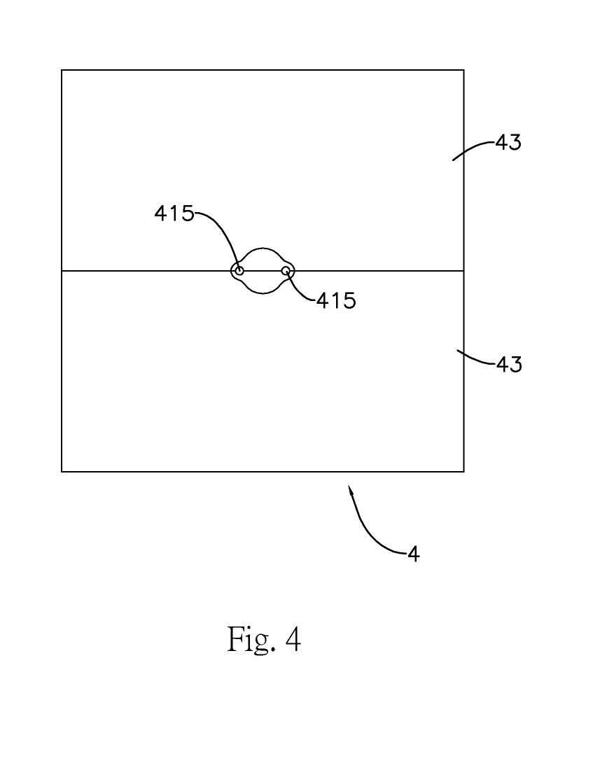

Please refer to FIGS. 2 to 5, which show the soaked ball core 1 placed in ball cover mold 4 (FIG. 2). The mated mold is then lodged in the mold holder 43 to be heated at approximately 70° C. for 2 hours to form ball cover 5. In this embodiment, the ball cover mold 4 consists of two figure-8 ball cover shaping mold pieces 41, which fit together to form the cover of a ball body, and a metal mold holder 43, which allows the two figure-8 ball cover mold pieces to stay tightly engaged in the heating and curing process. After the two figure-8 ball cover shaping mold pieces join together, the mated mold is placed in the mold holder 43 (as shown in FIGS. 3, 4 and 5). After heated and cured, the appearance of a finished ball is formed inside the two figure-8 ball cover shaping mold pieces 41 (as shown in FIGS. 3, 4 and 5). In this invention, the two figure-8 ball cover shaping mold pieces 41 are made of a soft or flexible plastic material, thereby making it possible to separate and move away from each other when lodging the soaked ball core inside the molds and dislodging the finished ball out of the molds. The two figure-8 ball cover shaping mold pieces include stepped overlapping edges 411 with stitch shaped grooves 413 set on the interior side along these overlapping edges 411. The stitch shaped grooves 413, which mimic the stitched seams of a conventional baseball or softball, form simulated stitched seams on the exterior of the finished ball cover 5. Two small overflow spouts 415 are each set and positioned in between the abutting edges of the two figure-8 ball cover shaping mold pieces. During the heating and curing process, trapped air and excess Polyurethane liquid are expelled through these overflow spouts (as shown in FIGS. 2 and 4). Preferably, a cowhide grain pattern is embossed on the interior of the ball cover shaping mold 4 (not shown) to form a cowhide grain texture on the finished ball surface.

More importantly, the two mold pieces of the figure-8 ball cover shaping mold 41 are corresponding and interlocking, so that when they join together, the mold parting line coincides on the center line of the simulated stitched seams of the finished ball, hence greatly adding to esthetics of the ball.

In this invention, the ball cover mold 4 is not restricted to the figure-8 ball cover shaping mold, but can also be constructed using two attaching hemispherical mold pieces, which do away with injection inlets. The two hemispherical mold pieces are made with simulated stitched seams on the interior wall of the semicircular cavity and are installed with 2 small overflow outlets, which are set opposite each other on the abutting edges of the molds and positioned at the center of the stitch shaped grooves on the interior wall of the molds. During the molding process, the two small overflow spouts allow trapped air and excess Polyurethane liquid to be discharged.

In this invention, the fibrous layer 2 wrapped over the ball core is infused in advance with liquid Polyurethane before it is placed into two figure-8 ball cover shaping mold pieces 41. Therefore, it is no longer necessary to build the injection spouts on the mold pieces 41, thereby eliminating the problem of hardened Polyurethane lumps resulting on the ball cover 5. Additionally, as the two overflow spouts 415 are made very small, set and positioned in between the abutting edges of the two figure-8 ball cover shaping mold pieces, when the molds are removed, tiny protrusions left of the overflow spouts reside at the center line of the simulated stitched seams of the finished ball 5 and are easy to be trimmed off, adding to cosmetic quality of the ball.

Most importantly, it is no longer necessary to install protruding pins, which are fixed on the interior wall of mold pieces 41 to support the ball core, thereby eliminating the problem of balls being produced with inconsistent thickness across the finished ball cover.

Because the layer of fibrous material as a base fully impregnated with liquid Polyurethane is wrapped over the independent ball core, the Polyurethane liquid simultaneously infiltrates and bonds itself firmly onto the surface of the ball core. The heating and curing process that follows transforms it into a molded ball cover integral to the ball body. The finished ball cover thereby gets to acquire comparable durability strength to genuine leather ball cover and when in play, the ball cover greatly holds up the durability of the ball upon vigorous batting impacts.

Finally the molds are removed to reveal the finished ball. To assume the appearance of the stitching of a conventional baseball or softball, paint or ink of mandatory stitch color of regulation balls is preferably applied on the simulated stitches of the finished ball by using a masking tooling, which covers the ball body but exposes only the stitches thereon.

This invention, by using ball cover mold 4 to directly form the finished ball cover 5 and utilizing mechanized production techniques, will greatly increase production rates, reduce the production steps and save huge costs of manual labor spent on hand-stitching the conventional balls. Furthermore, the uniformity of the molded balls in finished size and the consistency of cover thickness can be guaranteed, greatly adding to durability and lifespan of the balls.

To sum up, it can be seen that this production method for forming a baseball or softball cover shows an innovative process to manufacture balls, which is presently non-existent. The novelty of this invention shall be in no doubt. Additionally this invention has unique characteristics and functions superior to the ones of the prior art, showing that this invention certainly has inventive steps and meets all the requirements of a patent as set out by this patent office.

The above shows the best embodiment of this invention, but the structural characteristics of this invention are not limited to the above.

What is claimed is:

1. A production method for forming a baseball or softball cover, which comprises the following steps:
forming a ball core independently;
fixing a fibrous layer as a base material structured in an even thickness over the outer surface of the ball core, and applying a liquid Polyurethane material to fully permeate this fibrous layer;
placing the soaked ball core into ball cover mold and then again lodging the ball cover mold in a metal mold holder;
heating to cure the liquid polyurethane and form the shape of a ball cover;
removing the mold to reveal the complete ball.

2. The production method of claim 1, wherein the ball core is one of the existing ball cores commonly used in regulation baseballs and softballs; which is made of Polyurethane, rubber, cork, composite, or wool yarns wound in multiple layers; and which can also be made in a combination of any of the aforementioned materials.

3. The production method of claim 1, wherein the fibrous layer is porous and constructed of pile, felt, natural or synthetic fibers, natural or synthetic yarns, natural or synthetic non-woven cloth, natural or synthetic woven cloth, or a combination, either wound or laminated, of two or more of the aforementioned materials.

4. The production method of claim 3, wherein the fibrous layer is structured of a consistent thickness whether it is a single piece, padded, laminated, or wound.

5. The production method of claim 3, wherein the fibrous layer comprise a thickness of between approximately 1.2 mm to 1.4 mm, preferably at 1.3 mm to make for the finished thickness of the regulation baseball cover; or a thickness of between approximately from 1.4 mm to 1.6 mm, preferably at 1.5 mm for the regulation softball cover.

6. The production method of claim 3, wherein the fibrous layer is injected, sprayed or brushed with the liquid Polyurethane.

7. The production method of claim 1, wherein the ball cover mold consists of a figure-8 ball cover shaping mold and a metal mold holder.

8. The production method of claim 7, wherein the figure-8 ball cover shaping mold comprises two mold pieces, which are made of a soft or flexible plastic material and in the shape of a clamshell.

9. The production method of claim 8, wherein the mold parting line of the two figure-8 ball cover shaping mold pieces is made to coincide on the center line of the simulated stitched seams of the finished ball.

10. The production method of claim 8, wherein the two figure-8 ball cover shaping mold pieces, which dispense with injection inlet, are built with stitch shaped grooves on the abutting edges and cowhide grain pattern on the interior thereof.

11. The production method of claim 8, wherein two overflow spouts are each set and positioned in between the abutting edges of the two figure-8 ball cover shaping mold pieces.

12. The production method of claim 1, wherein the ball cover mold is made of a mold cavity with two attaching hemispherical mold pieces, which dispense with injection inlet;
which are built with stitch shaped grooves and cowhide grain pattern on the interior thereof.

13. The production method of claim 12, wherein two overflow spouts are installed opposite each other in the molds, each being positioned at the center of the stitch shaped grooves and set on the abutting edges of the two attaching hemispherical mold pieces.
